(19) United States
(12) Patent Application Publication
(10) Pub. No.: US 2007/0078045 A1
(43) Pub. Date: Apr. 5, 2007

(54) ROLLER USED FOR IMAGE FORMING APPARATUS

(75) Inventors: Hiroshi SAHARA, Susono-shi (JP); Tohru Saito, Mishima-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/535,142

(22) Filed: Sep. 26, 2006

(30) Foreign Application Priority Data
Sep. 30, 2005 (JP) 2005-286484 (PAT.
Sep. 13, 2006 (JP) 2006-248102 (PAT.

(51) Int. Cl. F16C 13/00

(52) U.S. Cl. 492/47; 492/56

(57) ABSTRACT

The roller for an image forming apparatus includes a metal pipe, flanges pressed into both ends of the metal pipe by an interference fit, the flanges including shaft parts, and pins penetrating the metal pipe and the flanges, the pins pressed into both of the metal pipe and the flanges by the interference fit, wherein the pins have a quality of material having a linear expansion coefficient larger than those of the flanges, and the pins have the quality of material having the linear expansion coefficient larger than that of the metal pipe or the same quality of material as that of the metal pipe. Thereby, even if a large load is applied to the roller under a high temperature environment, the roller can secure its strength.

### BACKGROUND OF THE INVENTION

1. Field of the Invention

The present invention relates to a roller used for an image forming apparatus such as a copier, a printer and the like, and more particularly to a roller suitable to be used for a heat fixing device, on which a large load is weighted under a high temperature environment.

2. Description of the Related Art

A metal roller has been conventionally used for a copier, a printer, a facsimile machine and the like. As such a metal roller, there are a roller composed of a roller part and a shaft part which are integrally formed to be one body by drawing or cutting, and a roller produced by pressing a shaft part into a roller part to combine them into one body after forming them as separate bodies.

In the former metal roller, especially in the case where the difference between the outside diameters of the roller part and the shaft part is large, it is difficult to acquire the concentricity of the shaft part and the roller part with high accuracy, the production and the processing of the roller need a long time, and a large-scale apparatus becomes necessary.

Moreover, in the latter metal roller, a solid roller must be used in order to secure the depth of pressing of the shaft part, and consequently the cost pertaining to the roller part increases. Moreover, the solid roller also increases its weight, and then the handling at the time of assembling the device becomes difficult. When the metal roller is used for a unit including the metal roller which is exchanged by a user, the problem of usability is also brought about.

Accordingly, in Japanese Patent Application Laid-Open No. H10-281140, a technique to press a flange into a metal pipe and to fixate the flange to the metal pipe by welding has been proposed. According to such an art, the flange in which a shaft part is integrated is pressed into the metal pipe, and is fixated to the metal pipe by welding. Consequently, the concentricity between the shaft part and the roller part can be acquired with high accuracy.

Moreover, because the metal pipe is used, the inside of the roller is hollow, and the cost needed for the roller part can be also suppressed. Moreover, because the inside of the roller is hollow, the weight as the metal roller can be trimmed, and the handling at the time of the assembly of the apparatus and an exchange of the unit becomes easy.

However, in the art disclosed in Japanese Patent Application Laid-Open No. H10-281140, because a facility for performing the welding process becomes necessary in the viewpoint of production processing to press the metal pipe into the welding of the flange, the unit cost of parts becomes high.

FIGS. 3A and 3B are the schematic sectional views of the conventional type of metal roller as disclosed in the Japanese Patent Application Laid-Open No. H10-281140. As shown in FIG. 3A, a metal roller 400 includes a metal pipe 401, flanges 402 and welding parts 403 at which the metal pipe 401 and the flanges 402 are welded with each other. The flanges 402 severally include a shaft part 404, and the shaft parts 404 have the same center (concentric) as that of the metal pipe 401 and extend to the outside.

When the metal roller 400 is used for, for example, a fixing unit in an image forming apparatus or the like, the metal roller 400 receives a pressure 405 on all over the periphery of the metal pipe 401. The pressure 405 becomes to be greatly large to be within a range of from 1 to 100 kg, and the metal roller 400 is always pressurized from one side. Moreover, sometimes, the pressure is once released and is pressurized again at the time of performing jam processing or the like. Moreover, because the rotation speed of the metal roller 400 varies according to the kind of a transfer material to which an image is output, and the metal roller 400 repeats being driven and stopped.

Consequently, while the metal roller 400 always bears a high load and irregularly receives a rapid load change, the metal roller 400 repeats the start and the stop of rotations of a plurality of speeds. Therefore, very large loads are repeatedly implied on the combination parts of the flanges 402 and the metal pipe 401.

Thereby, the flanges 402 deform as shown in FIG. 3B, and finally the flanges 402 become in the state of coming out of the metal pipe 401. In such a condition, the welding parts 403 cannot be a sufficiently effective measure against the deformation of the flanges 402. Moreover, for avoiding the deformation, although it is effective to set the pressing margins of the flanges 402 to be large, the usability and cost are sacrificed by the increase of weight.

Moreover, Japanese Patent No. 2911543 and Japanese Patent Application Laid-Open No. S63-084827 describe to press flanges into a metal pipe and then to combine the flanges and the metal pipe with pins after the pressing.

However, the configuration of simply combining the flanges with the metal pipe with the pins is not sufficient in strength as a roller used for an image forming apparatus, especially as a roller used for a heat fixing device weighted by a large load under a high temperature environment.

### SUMMARY OF THE INVENTION

The present invention has been made in consideration of the problems mentioned above. An object of the present invention is to provide a roller capable of securing the strength thereof even if a large load is weighted thereon under a high temperature environment.

Another object of the present invention is to provide a roller capable of being manufactured at a low cost to be light in weight and capable of securing the strength thereof.

A further object of the present invention is to provide a roller optimum to be installed in a heat fixing device.

A further object of the present invention is to provide a roller including a metal pipe; flanges secured at both ends of said metal pipe by an interference fit, said flanges including shaft parts; and pins penetrating said metal pipe and said flanges, said pins secured to both of said metal pipe and said flanges by an interference fit, wherein said pins are made of material having a linear expansion coefficient larger than a linear expansion coefficient of said flanges, and said pins are made of material having a linear expansion coefficient larger than a linear expansion coefficient of said metal pipe or the same material as that of said metal pipe.

A still further object of the present invention will become apparent from the following detailed description of exemplary embodiments with reference to the attached drawings.

### BRIEF DESCRIPTION OF THE DRAWINGS

FIG. 1 is a sectional view of a heat fixing device using a roller according to the present invention when it is seen from the upper stream side in the recording paper conveyance direction;

FIG. 2 is a configuration diagram of an image forming apparatus installing the heat fixing device using the roller according to the present invention; and

FIGS. 3A and 3B are schematic sectional views of a conventional metal roller.

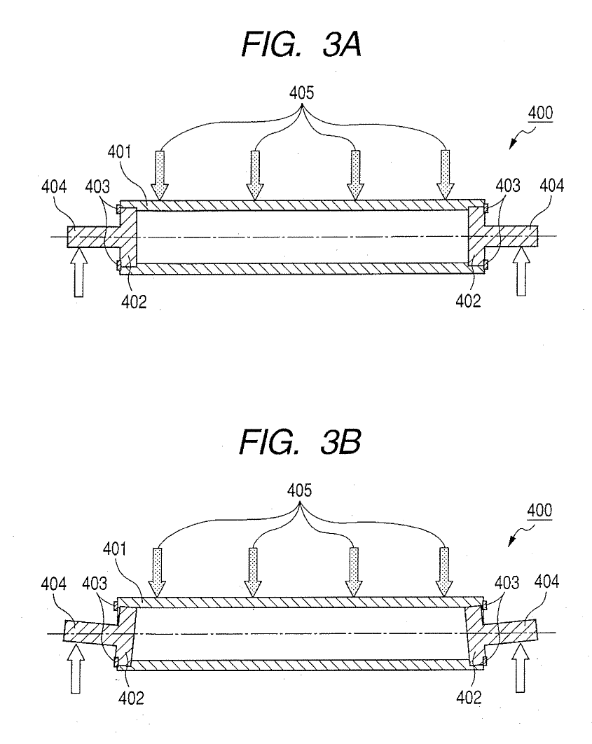

### DETAILED DESCRIPTION OF THE PREFERRED EMBODIMENTS

(Image Forming Apparatus)

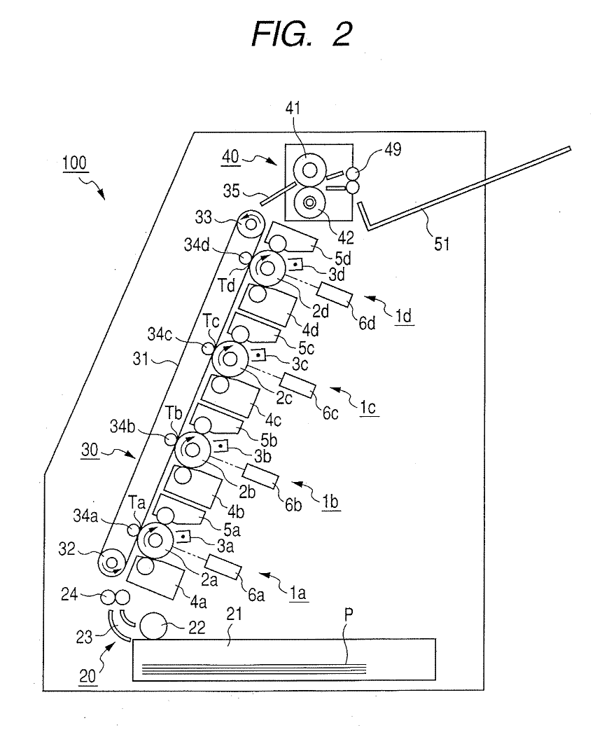

FIG. 2 is a configuration diagram of an image forming apparatus installing a heat fixing device using a roller according to the present invention. As shown in FIG. 2, the image forming apparatus 100 is an in-line type full color printer of an electrophotography system. The image forming apparatus 100 is provided with four image forming parts (image forming units) of image forming parts 1a, 1b, 1c and 1d. These four image forming parts 1a-1d are arranged in one row with a fixed interval between each of them. The image forming parts 1a-1d form images of a yellow color, a magenta color, a cyan color and a black color, respectively.

Drum type electrophotography photosensitive members (hereinafter referred to as photosensitive drums) 2a, 2b, 2c and 2d as image carrying bodies are installed in the image forming parts 1a-1d, respectively. Around each of the photosensitive drums 2a-2d, charging devices 3a, 3b, 3c and 3d, developing devices 4a, 4b, 4c and 4d, and drum cleaning devices 5a, 5b, 5c and 5d are installed, respectively. Exposure devices 6a, 6b, 6c and 6d are installed above the spaces between each of the charging devices 3a-3d and each of the developing devices 4a-4d, respectively. A yellow toner, a magenta toner, a cyan toner and a black toner are housed in each of the developing devices 4a-4d, respectively.

Moreover, the image forming apparatus 100 includes a sheet feeding part 20, a conveying device 30 and a fixing device 40.

The sheet feeding part 20 includes a sheet feeding cassette 21, a sheet feeding roller 22, transfer material conveying guides 23 and registration rollers 24.

The conveying device 30 includes transfer rollers 34a-34d, a tension roller 32 and a drive roller 33. The transfer rollers 34a-34d abut on the respective photosensitive drums 2a-2d with an endless belt-shaped transfer material conveying belt (hereinafter referred to as a transfer belt) 31 put between them at nip parts of respective transferring parts Ta, Tb, Tc and Td. The transfer belt 31 is laid across in a tensioned condition between the tension roller 32 and the drive roller 33, and is rotated (moved) into the conveying direction (conveyance direction) of a transfer material P by the drive of the drive roller 33.

The fixing device 40 is installed on the downstream side in the conveyance direction of the transfer belt 31. The fixing device 40 includes a pressure roller 41 and a heating roller 42. The pressure roller 41 is pressurizing means which pressurizes a transfer material. The heating roller 42 is heating means which surrounds a heat source for heating the transfer material.

(Image Forming Operation)

Next, the image forming operation by the image forming apparatus 100 is described. When an image formation start signal is input, each of the photosensitive drums 2a-2d of each of the image forming parts 1a-1d, respectively, is driven to rotate at a predetermined process speed. Each of the photosensitive drums 2a-2d is severally charged to have a negative polarity uniformly by the charging devices 3a-3d, respectively. The exposing devices 6a-6d severally converts an image signal corresponding to an output image into a light signal by a laser outputting part (not shown), and emits the laser light which is the converted light signal. Each of the charged photosensitive drums 2a-2d is scanned to be exposed by the laser light, and an electrostatic latent image is formed on each of the photosensitive drums 2a-2d.

Next, the process of adhering toner to an electrostatic latent image to perform development, and the processes after this process are described. First, yellow toner is adhered to the electrostatic latent image formed on the photosensitive drum 2a by the developing device 4a, on which a developing bias of the same polarity as the charging polarity (negative polarity) of the photosensitive drum 2a is applied, and a visible image is formed as a toner image on the photosensitive drum 2a.

On the other hand, the transfer material P, which is loaded in the sheet feeding cassette 21, is guided by the transfer material conveying guides 23 while the transfer material P is fed by the sheet feeding roller 22. The fed transfer material P is conveyed to the transferring part Ta by the registration rollers 24 according to the timing at which the end of the toner image on the photosensitive drum 2a moves to the transferring part Ta between the photosensitive drum 2a and the transfer roller 34a. The transfer material P, which has been conveyed to the transferring part Ta, receives the transfer of the yellow toner image by the transfer roller 34a, on which a transfer bias (having the polarity (positive polarity) reverse to that of the toner) is applied.

The transfer material P, on which the yellow toner image has been transferred, is moved to the image forming part 1b by the transfer material conveying belt 31. Then, also in the transferring part Tb composed of the image forming part 1b and the transfer roller 34b, similarly a magenta toner image formed on the photosensitive drum 2b is superimposed on the yellow toner image on the transfer material P to be transferred. In the following, similarly, the toner images of cyan and black are sequentially superimposed in each of the transferring parts Tc and Td, and a full color toner image is formed on the transfer material P.

The transfer material P, on which the full color toner image has been formed, is conveyed to the fixing device 40 by a conveyance guide 35. The transfer material P, which has been conveyed to the fixing device 40, is heated and pressurized at a fixing nip between the heating roller 42 and the pressure roller 41, and the heat fixing of the full color toner image is performed. The transfer material P, on which the heat fixing of the toner image has been performed, is ejected onto an ejection tray 51 by ejection rollers 49. At that time, the series of image forming operation is terminated.

In addition, transfer remain toner remaining on each of the photosensitive drums 2a-2d at the time of the transfer of the image from the photosensitive drums 2a-2d to the transfer material P is removed to be recovered by each of the drum cleaning devices 5a-5d, respectively.

Moreover, at the time of outputting a monochrome image, the above image forming process is performed only at the image forming part id for forming a black color image.

(Fixing Device 40)

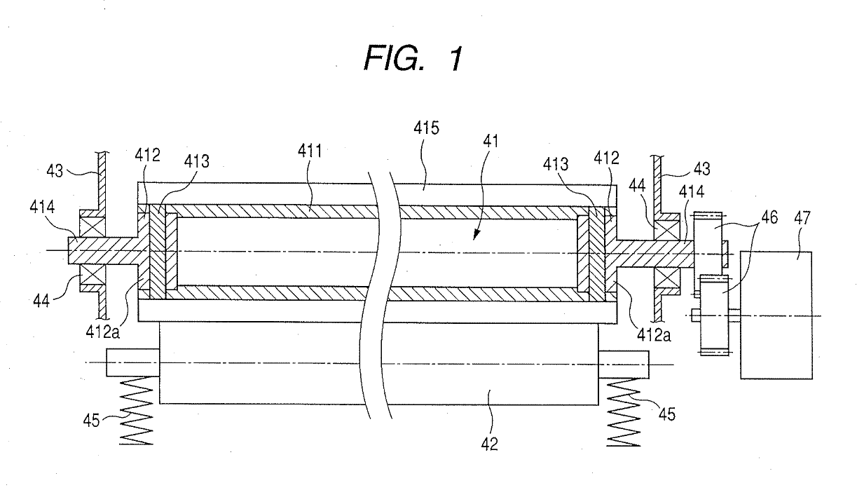

Next, the fixing device 40 is described in detail. FIG. 1 is a sectional view of the principal part of the fixing device 40 when it is seen from the upstream side in the conveyance direction.

As shown in FIG. 1, the pressure roller 41 includes an elastic member 415 and a metal roller having a metal pipe 411, flanges 412 and pins 413.

The metal pipe 411 is a hollow pipe made of a metal, and the flanges 412 are pressed into both ends of the metal pipe 411(secured by the interference fit).

Each of the flanges 412 includes an extended part 412a and a shaft part 414. The extended part 412a is formed to be a disk having the substantially same diameter as the inner diameter of the metal pipe 411 (a little larger diameter). The shaft part 414 has the same center (concentric) as the metal pipe 411, and extends to the outside.

Each of the pins 413 penetrates the metal pipe 411 and the flange 412 in a direction (radial direction) perpendicular to the shaft direction at the joining part of the metal pipe 411 and the flange 412. The elastic member 415 is formed on the periphery of the metal pipe 411, and forms an elastic layer. The elastic layer is formed on the surface of the metal pipe 411 so as to cover the parts of the metal pipe 411 where the pins 413 penetrate the metal pipe 411.

Now, when the cost of the roller 41, the weight and the strength of the roller 41, and the like are totally considered, iron is preferable as the material of the flanges 412, and aluminum is preferable as the material of the metal pipe 411. This is because iron has a density higher than that of aluminum by about three times and the metal pipe 411 made of iron would be very heavy. Accordingly, when the lightening of the roller is considered, it is preferable to produce the metal pipe 411 with aluminum. Also as for the cost, the pipe made of aluminum can be finished to be cheaper than the pipe made of iron.

On the other hand, because the shaft part 414 of the flanges 412 bears a large load, the flanges 412 are preferably made of iron, which has a larger strength than that of aluminum.

As described above, when the cost of the roller 41, the weight and the strength of the roller 41 and the like are totally considered, iron is preferable as the material of the flanges 412, and aluminum is preferable as the material of the metal pipe 411.

However, because the linear expansion coefficient of aluminum is larger than that of iron, there is the possibility that the interference fit state of the metal pipe 411 and the flanges 412 is loosened when the temperature of the roller 41 rises.

Accordingly, the present embodiment provides a configuration capable of suppressing the looseness between the metal pipe and the flanges caused by a temperature rise even if the metal pipe is made of a material having a larger linear expansion coefficient than that of the material of the flanges.

The pins 413 used in the present embodiment is made of the same material as that of the metal pipe 411, and is pressed into the metal pipe 411 and the flanges 412 to penetrate the metal pipe 411 and the flanges 412. That is, the pins 413 is subjected to the interference fit to the metal pipe 411 and the flanges 412. Moreover, the metal pipe 411 and the pins 413 use members each having a linear expansion coefficient larger than those of the flanges 412. That is, the pins 413 are made of a material having a linear expansion coefficient larger than that of the flanges 412, and the pins 413 are made of the same material as that of the metal pipe 411. For example, it is preferable to use aluminum as the materials of the metal pipe 411 and the pins 413 and to use iron as the material of the flanges 412.

In addition, the material of the pins 413 may be set to have the relation in which the pins 413 are made of a material having a linear expansion coefficient larger than those of the flanges 412, and in which the pins 413 are made of the material having the linear expansion coefficient larger than the metal pipe 411.

Thereby, even if the pressure roller 41 is heated by the heating roller 42, because the pins 413 pressed into the flanges 412 (interference fit state) and pressed into the metal pipe 411 (interference fit state) are not loosened by thermal expansion, the metal pipe 411 and the flanges 412 can keep their strong combination.

Moreover, the flanges 412 have received knurling on the joint surfaces with the metal pipe 411, and are reinforced lest the flanges 412 should fall out from the metal pipe 411. In addition, the joint surfaces of the metal pipe 411 with the flanges 412 may be subjected to knurling to be reinforced lest the flanges 412 should fall out from the metal pipe 411.

The elastic member 415 is made of silicone rubber, and further a mold releasing layer made of a fluoride resin is formed on the surface of the silicone rubber. The outside diameter φ of the pressure roller 41 including the elastic member 415 is desirably within a range of from 10 mm to 50 mm.

Each of the shaft parts 414 is supported by a side plate 43 with a bearing 44 put between them. Drive transfer gears 46 are fixed to one of the shaft parts 414 to transfer the drive rotations of a drive motor 47, which is drive means, to the pressure roller 41. The drive motor 47 can switch a plurality of conveyance speeds according to the kind of a transfer material to be fixed.

On the other hand, the heating roller 42 includes a heat source (not shown) in its inside, and the temperature of the periphery of the heating roller 42 rises up to a temperature within a range of from 150° C. to 200° C. in order to fix the un-fixed toner image on a transfer material. Moreover, the heating roller 42 is urged toward the pressure roller 41 by pressurizing springs 45. The abutting pressure (pressure) at this time is preferably within a range of from 1 kg to 100 kg. Moreover, the abutting pressure can be adjusted by not shown pressure adjusting means.

Now, a high pressure (1-100 kg) always operates on the whole area of the periphery of the pressure roller 41 from one direction from the heating roller 42. Moreover, the pressure applied onto the pressure roller 41 changes according to the pressure adjustment by the pressure adjusting means according to the kind of the transfer material and jam processing (the pressurized state is once released and pressurization is again performed). Moreover, the drive motor 47 is set to change its speed according to the kind of the transfer material, and then the pressure roller 41 includes a plurality of rotation speeds. When the speed of the pressure roller 41 changes, the rotation speed of the heating roller 42, which follows the rotation of the pressure roller 41 to rotate, changes (including a stop).

Consequently, the pressure roller 41 always bears a high load while the pressure roller 41 irregularly receives rapid load changes and repeats the starts and the stops of rotations at a plurality of speeds. Consequently, very large loads are repeatedly applied on the combination parts of the flanges 412 and the metal pipe 411.

Even in such a case, because the flanges 412 are strongly combined with the metal pipe 411 by the pins 413, the flanges 412 never deform. Moreover, the flanges 412 also never fall out from the metal pipe 411 by the operation of the pins 413, and the stable operation of the pressure roller 41 can be ensured.

Moreover, the pins 413 are made of the same material as that of the metal pipe 411, and the linear expansion coefficients of the pins 413 are larger than those of the flanges 412. Consequently, even if the pressure roller 41 is heated by the heating roller 42, the pressed states between the pins 413 and the metal pipe 411 and the pressed states between the pins 413 and the flanges 412 do not loosen owing to the thermal expansion, and strong combinations can be held.

Moreover, because the metal pipe 411 is hollow, the weight of the pressure roller 41 can be reduced. Consequently, the handling at the time of the combination of the fixing device 40 (image forming apparatus 100) and at the time of exchange of the fixing device 40 (fixing unit) is easy and simple. Moreover, the cost of the pressure roller 41 can be suppressed.

In addition, even if the metal roller (including the metal pipe 411, the flanges 412 and the pins 413) is used for the heating roller 42, it is similarly available. Moreover, the metal roller like the embodiment mentioned above may be used for the supporting roller (the tension roller 32 and the drive roller 33) of the conveying device 30 using the endless belt (the transfer belt 31). In particular, the drive roller 33 nearest to the fixing device 40 always receives the tension of the transfer belt 31 from one direction, and the drive roller 33 approaches the fixing device 40 to be influenced by the heat of the fixing device 40. Consequently, if the roller as the present embodiment is used as the drive roller 33, the similar effects to those in case of using the roller to the fixing device 40 can be acquired. Moreover, in an image forming apparatus of an intermediate transfer system, if the metal roller like the present embodiment is used as the supporting roller of the intermediate transfer belt unit, similar effects can be acquired.

The present invention is not restricted to the embodiment mentioned above, and modifications and variations within the scope and the sprit of the present invention can be included in the present invention.

This application claims the benefit of Japanese Patent Application No. 2005-286484, filed Sep. 30, 2005, and No. 2006-248102, filed Sep. 13, 2006, which are hereby incorporated by reference herein in their entirety.

What is claimed is:

1. A roller used for an image forming apparatus, comprising:
a metal pipe;
flanges secured at both ends of said metal pipe by an interference fit, said flanges including shaft parts; and
pins penetrating said metal pipe and said flanges, said pins secured to both of said metal pipe and said flanges by an interference fit,
wherein said pins are made of material having a linear expansion coefficient larger than a linear expansion coefficient of said flanges, and said pins are made of material having a linear expansion coefficient larger than a linear expansion coefficient of said metal pipe or the same material as that of said metal pipe.

2. A roller according to claim 1, wherein at least one of joint surfaces of said metal pipe and said flanges is subjected to knurling.

3. A roller according to claim 1, further comprising:
an elastic layer formed on a surface of said metal pipe so as to cover portions of said metal pipe where said pins penetrate said metal pipe.

4. A roller according to claim 1, wherein said metal pipe is made of material having a linear expansion coefficient larger than a linear expansion coefficient larger of said flanges.

5. A roller according to claim 1, wherein said roller is a roller used for a heat fixing device installed in said image forming apparatus.

6. A roller according to claim 1, wherein said roller is a roller used for belt drive to be installed in said image forming apparatus.
